(19) United States
(12) Patent Application Publication
(10) Pub. No.: US 2005/0100671 A1
(43) Pub. Date: May 12, 2005

(54) Electronic watermarking apparatus and method

(76) Inventors: Yoko Kawada, Kawasaki (JP); Eriko Koda, Yokohama (JP); Akemi Nakashiro, Atsugi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/886,635

(22) Filed: Jul. 9, 2004

(30) Foreign Application Priority Data
Nov. 6, 2003 (JP) 2003-377148

(51) Int. Cl. B05D 5/00; B05C 11/00

(52) U.S. Cl. 427/256; 118/668

(57) ABSTRACT

An information processing apparatus is used to embed electronic watermark information. An input digital motion image is displayed on a display device. Using an input device, part of the displayed digital motion image is specified as an embed area into which electronic watermark information is to be embedded. The electronic watermark information is specified by use of the input device as well. The specified embed area is followed by detecting its movement so that only the specified embed area is watermarked.

### CLAIM OF PRIORITY

The present application claims priority from the Japanese patent application JP2003-377148 filed on Nov. 6, 2003, the content of which hereby incorporated by reference into this application.

### BACKGROUND OF THE INVENTION

The present invention relates to an electronic watermarking apparatus and method for embedding an electronic watermark into images. In particular, the invention relates to a technique for embedding copy control information, copyright information and other information into digitalized monition image content information.

As a technique to embed another data into audio visual data, text data, etc., electronic watermarking has long been applied in order to provide data-related information and comments and protect the data from illegal treatments such as unauthorized reproduction.

Electronic watermarking must be designed so that the image quality deteriorated due to the watermarking may not be perceptible. While we are sensitive to changes in low frequency regions such as flat objects, we are not so sensitive to changes in high frequency regions such as edge portions. Conventionally, to take advantage of this characteristic, the strength of watermarking is raised where changes are not easy to perceive whereas the strength is lowered where changes are easy to perceive. This can secure the watermark detection reliability while minimizing its influence on the image.

The processing time required for watermarking increases in proportion with the size of the image to be watermarked. Conventionally, each image is entirely watermarked so that watermark information can be detected even if content cutout and other editing manipulations are done. This increases the processing time.

In the case of watermarking a motion image stream, the processing time increases in proportion with the number of frames to be watermarked. Accordingly, as disclosed in Japanese Patent Laid-open No. 2002-171494, a technique has been proposed which decreases the processing time by watermarking only one of every several frames or embedding a watermark across several frames. In this case, however, the watermark detection reliability deteriorates if frames or contents are extracted from the motion image stream. Owing to this lower robustness to cutout and other editing manipulations, it is usual that a watermark is embedded into every frame of a motion image stream.

In addition, techniques have been disclosed which embed identifier information to part of still image data as an electronic watermark. For example, a rectangular area of a still image is watermarked with descriptive information so that the image can be retrieved with keywords as disclosed in Japanese Patent Laid-open No. 2001-109756.

Meanwhile, a technique to use the motion vector of the motion image to be watermarked is disclosed in Japanese Patent Laid-open No. 2002-369161. In this technique, one frame is divided into several blocks, then the motion vector of each of which is calculated. According to the calculated motion vectors, one general motion information is set to the frame. The electronic watermark is moved according to the motion information set to the frame.

### SUMMARY OF THE INVENTION

In the conventional methods, the processing time required to watermark a motion image stream increases in proportion with the image size and the length of the content. In addition, it is not possible to selectively protect a specific part of the content.

The prior art disclosed in Japanese Patent Laid-open No. 2001-109756 is a technique to embed identifying watermark information into part of still image data and does not concern motion images. If this technique is applied to a motion image stream, in order to watermark an object whose position changes depending on the frame, it is necessary to specify an embed region for each frame.

The prior art disclosed in Japanese Patent Laid-open No. 2002-369161 requires the time to calculate the motion vectors of all blocks and the time to watermark each whole frame. A piece of motion information is set to the entire frame and the electronic watermark is moved according to the motion information. Since the watermarking strength is not changed on an each frame basis, moving the watermark rather deteriorates the image quality as the case may be.

The following will describes an electronic watermarking apparatus and method capable of reducing the processing time required for electronic watermarking and selectively watermarking part of each motion image.

This electronic watermarking can be implemented with an information processor by following the steps of: displaying an input digital motion image on a display device; by use of an input device, specifying a part of the displayed digital motion image as an embed area into which electronic watermark information is to be embedded; by use of the input device, specifying the electronic watermark information; detecting a movement of the specified embed area; and locating the specified watermark information to the specified embed area according to the detected movement.

Additional objects, advantages and novel features of the examples will be set forth in part in the description which follows, and in part will be become apparent to those skilled in the art upon examination of the following and the accompanying drawings or maybe learned by production or operation of the examples. The objects and advantages of the inventive concepts may be realized and attained by means of the methodologies, instrumentalities and combinations particularly pointed out in the append claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a block diagram showing the configuration of an electronic watermarking apparatus;

FIG. 2 is a flowchart showing how an electronic watermarking program operates in the electronic watermarking apparatus by way of example;

FIG. 3 shows an example of the initial screen displayed in the electronic watermarking apparatus;

FIG. 4 shows an example of a screen displayed to specify an embed position in the electronic watermarking apparatus;

FIG. 5 shows an example of a screen displayed to set embed information in the electronic watermarking apparatus;

FIG. 6 is provided to explain how an embed target region moves in the electronic watermarking apparatus;

FIG. 7 is a block diagram showing the configuration of the watermarking unit in the electronic watermarking apparatus;

FIG. 8 is a flowchart showing how the electronic watermarking program operates in the electronic watermarking apparatus when a plurality of regions are to be watermarked, by way of example;

FIG. 9 is a diagram showing an example of an image where a plurality of regions are to be watermarked in the electronic watermarking apparatus; and

FIG. 10 is a flowchart showing how compressed motion images are watermarked in the electronic watermarking apparatus by way of example.

### DETAILED DESCRIPTION OF THE INVENTION

An embodiment of the present invention will be described below with reference to the drawings. Note that to designate each of identical elements that appear in the drawings, the same reference numeral is used without redundant description as a rule. Reference is not made in detail to the examples illustrated in the accompanying drawings and discussed below.

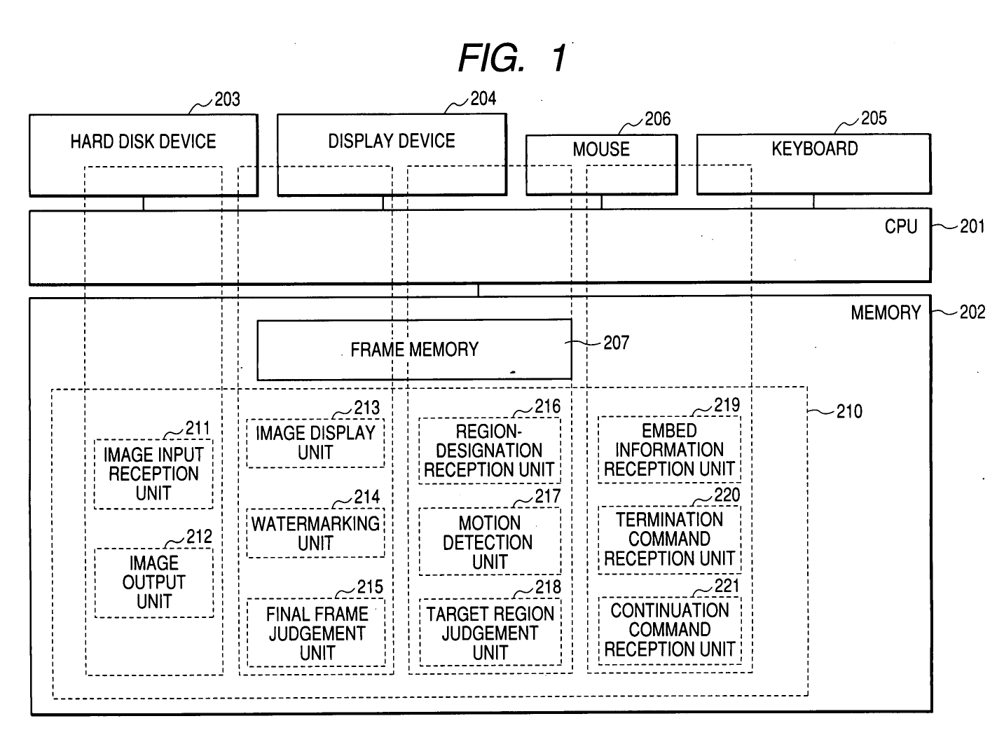

Referring to FIG. 1, the configuration of an electronic watermarking apparatus according to the embodiment of the present invention is described below at first. As in FIG. 1, the following description is made on the assumption that an example of an electronic watermarking apparatus is implemented by a computer. A computer to implement an electronic watermarking apparatus has a CPU 201, a memory 202, a hard disk drive 203, a display device 204, a keyboard 205, a mouse 206 and a frame memory 207.

In the memory 202, a watermarking program 210 which is run by the CPU 201 is stored. The watermarking program 210 comprises programs which respectively operate as: an image input reception unit 211, means operative to receive image input; an image output unit 212; an image display unit 213, means for display images; a watermarking unit 214, watermarking means; a final frame judgment unit 215; a region-designation reception unit 216, means operative to receive region designations; a motion detection unit 217, means for detecting motion vectors; a target region judgment unit 218; an embed information reception unit 219, means operative to receive embed information; and a termination command reception unit 220.

The electronic watermarking program 210 is run by the CPU 201. Trough operations of respective units of the electronic watermarking program 210, motion image data are taken in from the hard disk drive 203, mapped to the frame memory 207 and displayed on the display device 204.

The display device 204 is, for example, a LCD or CRT and can display one frame of motion image data at a time. By using the keyboard 205 or a pointing input device such as the mouse 206, the user can specify information which is to be embedded and designate a region to which the information is to be embedded.

Then the following provides a functional description of each unit of the electronic watermarking program 210.

The image input reception unit 211 is operative to receive motion image data from the hard disk device 203 or the like and store it in the memory 202.

The image display unit 213 is operative to receive motion image data from the image input reception unit 211 and display it on the display device 204. In addition, it recognizes a frame designated by the user as an image to be displayed. Thus, if a region the user wants to designate through the region-designation reception unit 216 is not present in the first frame, the user can designate a frame that may contain the region.

The region-designation reception unit 216 is operative to permit the user to designate an image region. It is assumed that the user specifies an image region via, for example, the mouse 206. Via the mouse 206, a rectangular image region, part of the motion image displayed on the display device 204, can be specified by dragging the cursor between two diagonal corners of the rectangular image region to be specified. Note that the region-designation reception unit 216 provides control so that either width or height of the rectangular region will be specified to be a multiple of one pixel block, which consists of 8×8 pixels.

The embed information reception unit 219 is operative to permit the user to specify watermark information. It is assumed that the user specifies watermark information via, for example, the keyboard 205. The motion detection unit 217 is operative to detect movement of the image region accepted by the region-designation reception unit 216. Hereinafter, such an image region which moves and is followed across frames is called an embed target region.

The watermarking unit 214 is operative to embed information accepted by the embed information reception unit 219 as an electronic watermark, into a segment detected by the motion detection unit 217 as an embed target region. The target region judgment unit 218 is operative to judge whether the embed target region being followed by the motion detection unit 217 is present in the frame.

The final frame judgment unit 215 is operative to judge whether the frame into which watermark information is embedded by the watermarking unit 214 is the final frame of the input image stream.

The termination command reception unit 220 is operative to accept a termination command from the user if it is judged by the target region judgment unit 218 that the embed target region is not present in the frame. It is also operative to accept a termination command from the user if there is no subsequent frame containing the embed target region when a frame is designated by the user.

The image output unit 212 is operative to record watermarked motion image data in the hard disk drive 203 as an image file if the last watermarked frame is judged as the final frame by the final frame judgment unit 215 or if the termination command reception unit 220 receives a termination command from the user.

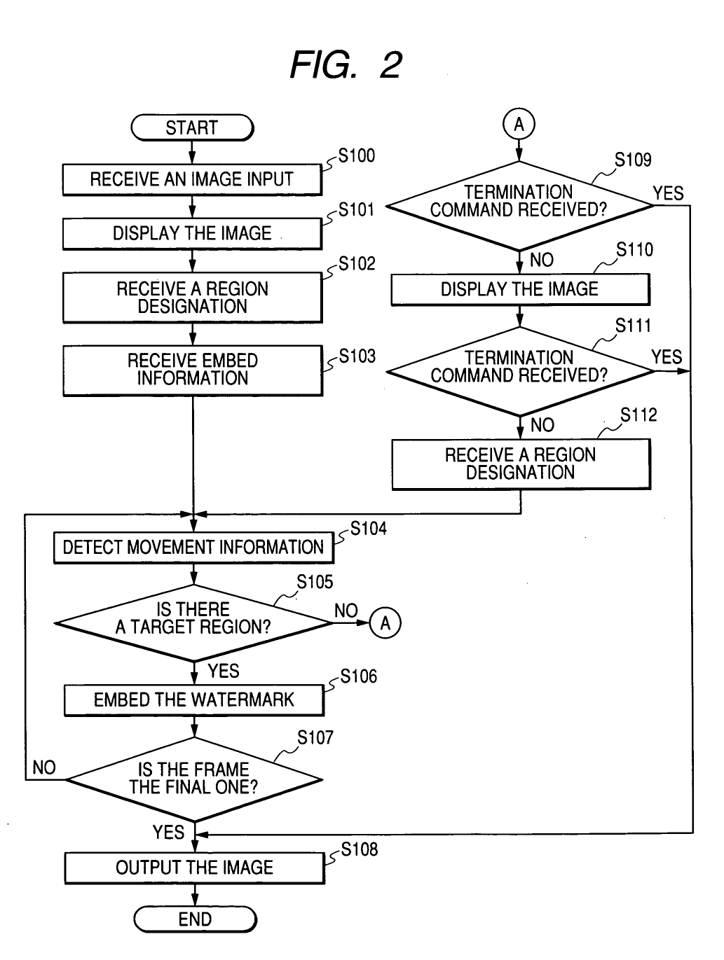

Then, the following describes how the electronic watermarking program 210 operates in the electronic watermarking apparatus embodiment of the present invention. FIG. 2 is a flowchart showing the operations of the electronic watermarking program.

Firstly in Step 100, the image input reception unit 211 receives motion image data and stores it in the memory 202. In Step 101, the image display unit 213 displays the motion image data received from the image input reception unit 211 on the display device 204.

In Step 102, the region-designation reception unit 216 permits the user to designate an image region. In Step 103, the embed information reception unit 219 permits the user to specify watermark information. In Step 104, the motion detection unit 217 detects the movement of the image region designated via the region-designation reception unit 216 and detects an embed target region for electronic watermarking.

In Step 105, the target region judgment unit 218 judges whether the embed target region being followed by the motion detection unit 217 is present in the frame. If the embed target region is present in the frame, the electronic watermarking program 210 goes to Step S106. In Step 106, the watermarking unit 214 embeds the watermark information received by the embed information reception unit 219 as an electronic watermark into a region detected by the motion detection unit 217 as the embed target region.

If it is judged in Step 105 that the embed target region is not present in the frame, the electronic watermarking program 210 goes to Step 109. In Step 109, the termination command reception unit 220 permits the user to issue a termination command. If continuation is instructed, the image display unit 213 displays the frame which does not contain the embed target region and then the image display unit 213 prompts the user to designate another frame in which the embed target region is expected to reappear.

That is, after the frame is displayed in Step 110, the user is permitted to designate another frame in Step 111. If there is no frame in which the embed target frame will reappear, the termination command reception unit 220 permits the user to issue a termination command. If continuation is instructed, the region-designation reception unit 216 permits the user to designate another image region in Step 112. In this case, control goes back to Step 104 in order to perform Step 104 and subsequent operations.

This makes it possible to embed the same information to the embed target region across frames even if the embed target region disappears in some frame but reappears in a subsequent frame.

In Step 107, the final frame judgment unit 215 judges whether the frame watermarked in Step 106 is the final frame of the input image stream. If the frame is not the final one, Step 104 and subsequent operations are performed on the next frame.

If the frame is judged as the final one in Step 107 or if a termination command is received either in Step 109 or Step 111, the image output unit 212 records the watermarked motion image data in the hard disk device 203 as an image file.

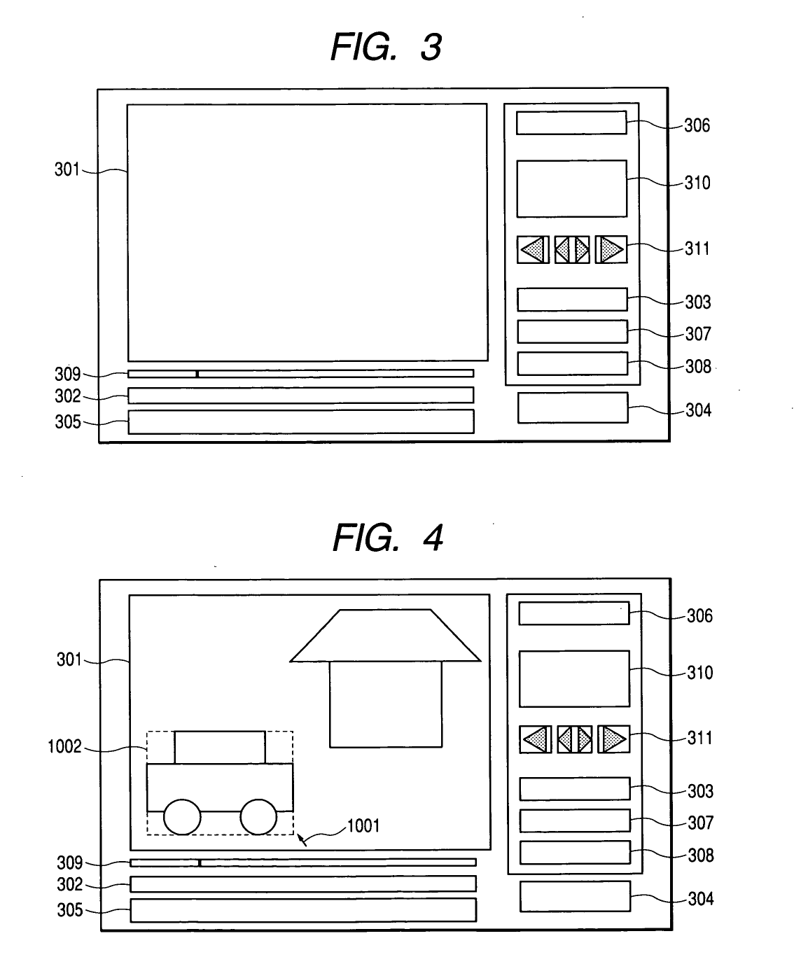

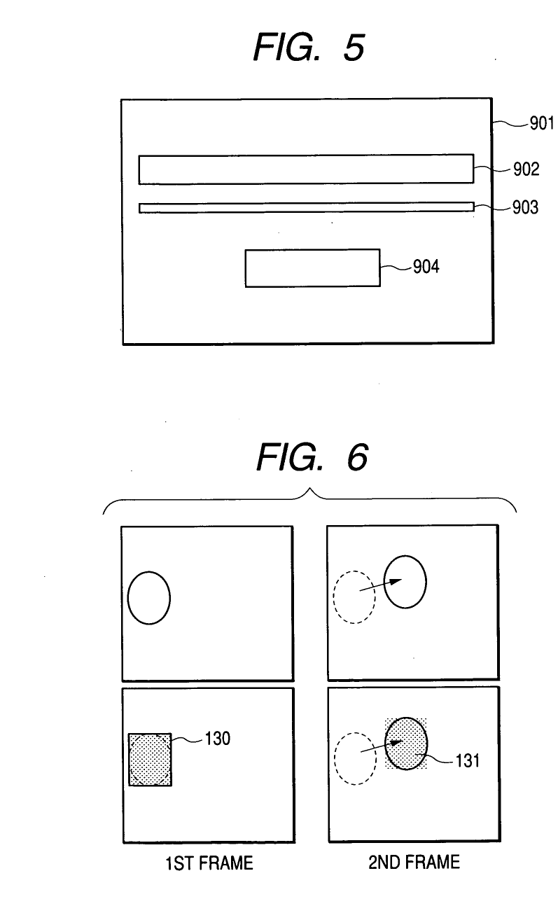

Then, with reference to FIGS. 3 to 5, the following describes examples of screens displayed while this watermarking apparatus embodiment of the present invention is running and examples of operations the user can perform via these displayed screens. FIG. 3 shows an example of the initially displayed screen. FIG. 4 shows an example of a screen displayed while an embed position is specified. FIG. 5 is an example of a screen displayed while embed information is set.

In FIG. 3, the displayed screen includes, for example, an image display section 301, an image display menu 302, an embed information setting screen display button 303, an operation start button 304, an input file designation button 305, an output filename specification section 306, a region determination button 307, a specified region confirmation button 308, a display frame scroll bar 309, an output format specification section 310 and embed direction designation buttons 311.

Hitting the input file designation button 305 displays, for example, a folder reference screen to make it possible to select an input file. An input file selected here is received by the image input reception unit 211 and a frame of the received motion images is displayed in the image display section 301.

The output filename specification section 306 accepts a filename specified therein as the name of a file to which the motion images are to be saved after watermarked. If the motion images are both watermarked and compressed, the output format specification section 310 accepts an output format condition specified therein.

The image display section 301 displays a digital motion image. On the image displayed in the image display section 310, the user selects a region with a pointing device such as the mouse 206. To specify a region as an embed region with the mouse 206, the user locates the cursor at the left corner of the area and clicks a mouse button. Then, with the mouse button held down, the user moves the cursor to the right corner of the region. As shown in FIG. 4, this operation selects a region 1002 in the image display section 301. The selected region 1002 is indicated by a dotted line.

Then, if the specified region confirmation button 308 is hit, the motion detection unit 217 performs motion detection processing on the motion images to continue highlighting the moving specified region by a dotted line. If the region determination button 307 is hit, the specified region 1002 is accepted as an embed target region.

If the user clicks on the image display section 301 without hitting the region determination button 307 after the region 1002 is specified, the user can specify another region.

The image display menu 302 permits the user to select a method in displaying a desired frame of the motion image stream in the image display section 301. The menu includes playback, stop, frame designation, etc.

The embed direction designation buttons 311 indicate whether the motion image stream is watermarked forward, backward or bidirectionally. Specifically, if the right arrow button is hit, electronic watermarking advances in the forward playback direction of the digital motion image stream according to motion information detected from forward frames. If the left button is hit, electronic watermarking advances in the reverse playback direction of the digital motion image stream according to motion information detected from backward frames. If the bidirectional arrow button is hit, electronic watermarking is performed bidirectionally. In the case of backward watermarking, electronic watermark information is embedded to the adjacent backward frame according to motion information detected between the region-specified frame and the adjacent backward frame. It is also possible to design the embodiment in such a manner that motion information is always detected relative to the embed target region specified in a previous frame which appears earlier than the current frame by a predetermined number of frames.

The display position scroll bar 309 indicates the temporal position of the current reproduced image in the whole motion image stream. By moving this, the user can select a frame to be displayed in the image display section 301. It is possible that an embed target region accepted by the region designation reception unit 216 is judged to be absent in the frame by the target region judgment unit 218. In this case, this scroll bar can be used to specify a frame in which the embed target region reappears, allowing the user to re-specify the region in the displayed frame as an embed target region effective in the subsequent frames. This scroll bar can also be used to search for a subsequent frame in which the specified region re-appear so that the specified electronic watermark information can be embedded.

Then, hitting the embed information setting screen display button 303 displays an embed information setting screen 901 as shown in FIG. 5. The embed information setting screen 901 contains an embed information setting section 902 which permits the user to type in information which is to be embedded in the motion image stream. It also has an embed strength setting section 903 which permits the user to set a strength value. After the embed information is entered, the user hits the information setting button 904. This displays the previous screen as shown in FIG. 3.

After the embed region and embed information are specified, the user hits the operation start button 304 to start the operation of the motion detection unit 217.

Referring to FIG. 6, the following description concerns the movement of an embed target region which is detected by the motion detection unit 217 in this electronic watermarking apparatus according to the embodiment of the present invention. FIG. 6 is provided to describe the movement of the embed target region.

The upper left illustration in FIG. 6 depicts a motion image displayed in the image display section 213. The lower left illustration indicates a user-specified region 130 accepted by the region-designation reception unit 216. The upper right illustration depicts a result of the motion detection unit 217 detecting the motion according to the difference between the current and previous frames. Based on this information, the user-specified region 130 is followed and detected as the embed target region 131 as depicted by the lower right illustration. That is, the user region 130 specified by the user is moved according to the motion of the region's internal image detected by the motion detection unit 217 and detected as the embed target region for electronic watermarking. The motion detection method used by the motion detection unit 217 complies with the international image encoding standard MPEG.

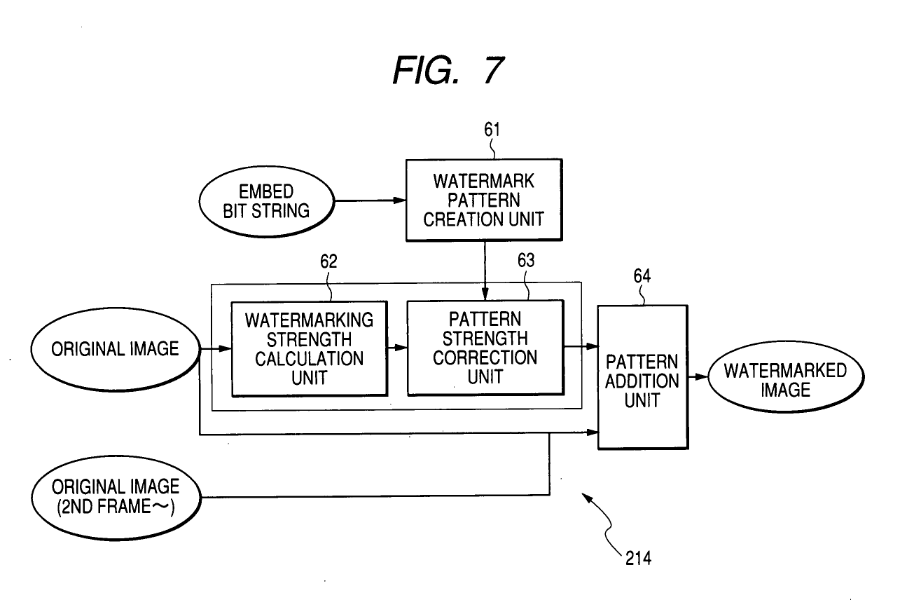

Referring to FIG. 7, the following describes the watermarking unit 214 in this electronic watermarking apparatus according to the embodiment of the present invention. FIG. 7 is a block diagram showing the functional configuration of the watermarking unit. In FIG. 7, the watermarking unit 214 comprises a watermark pattern creation unit 61, a watermarking strength calculation unit 62, a pattern strength correction unit 63 and a pattern addition unit 64.

The pattern creation unit 61 is operative to convert watermark information (for example, a embed bit string), accepted by the embed information reception unit 219, to a watermark pattern. The watermarking strength calculation unit 62 is operative to calculate the strength of watermarking the embed target region (the amount of pixel-to-pixel change from the original image) according to the image pattern and perceptual characteristics. The pattern strength correction unit 63 is operative to correct the watermark pattern according to the strength calculated by the watermarking strength calculation unit 62. The pattern addition unit 64 is operative to add the watermark pattern, created by the pattern strength correction unit 63, to the embed target region of the original image and to output the resulting-watermarked motion image.

In this embodiment, since the embed target region continues to represents the same object although the region moves, there is little difference between the embed target region in the first frame and that in the second frame. Therefore, in the electronic watermarking operation, the watermark pattern corrected based on the internal image of the embed target region in the first frame can be applied to the next frame.

For the second and subsequent frames of the original image stream, therefore, both watermarking strength calculation unit 62 and pattern strength correction unit 63 are not required to perform operations before the pattern addition unit 64 embeds the pattern. This makes it possible to reduce the time of processing by the watermarking unit 60.

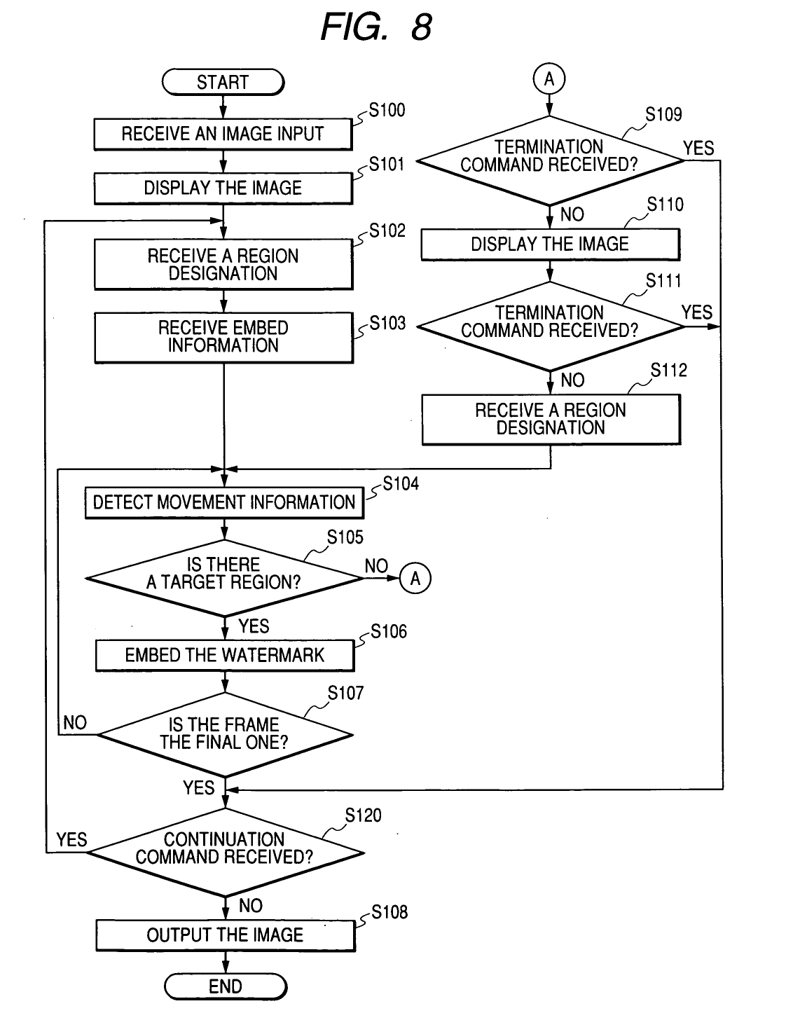

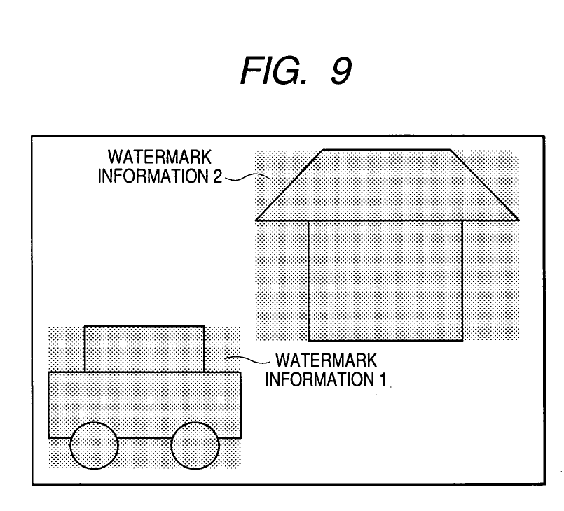

Referring to FIGS. 8 and 9, the following describes how the electronic watermarking program 210 in this electronic watermarking apparatus according to an embodiment of the present invention operates when watermark information is embedded into a plurality of regions. FIG. 8 is a flowchart illustrating the operations of the electronic watermarking program when electronic watermark information is embedded into a plurality of regions. FIG. 9 is an example of an image where electronic watermark information is embedded into a plurality of regions.

This electronic watermarking apparatus according to the embodiment permits the user to designate a specific region of a motion image as a region to be watermarked. Likewise, it is possible to designate different regions in the same motion image in order to embed information into a plurality of regions.

Steps 100 through 112 in FIG. 8 are same in operation as the corresponding steps shown in the flowchart of FIG. 2. FIG. 8 is different from FIG. 2 in that Step 120 is added. In Step 120, a command to continue the operation for watermarking can be accepted by the continuation command reception unit 221 constructed as part of the electronic watermarking program 210.

The continuation command reception unit 221 constructed as part of the electronic watermarking program 210 has a function to accept a command to permit the user to continue his setting operation for watermarking. It is assumed that the user issues this command by, for example, hitting a specific button on the screen or a specific key of the keyboard.

By this step, after embed information is specified for a specific region, the user can repeatedly specify different embed information for a different embed target region. Since an embed region can be specified with embed information, it is possible to embed different information into each of a plurality of regions in the same motion image (for example, watermark information 1 and watermark information 2 as shown in FIG. 9). Note that the procedure for embedding an electronic watermark into a specified object in a motion image stream, shown in FIGS. 2 and 8, can be started either from the beginning of the motion image stream or from any point between its first and final frames.

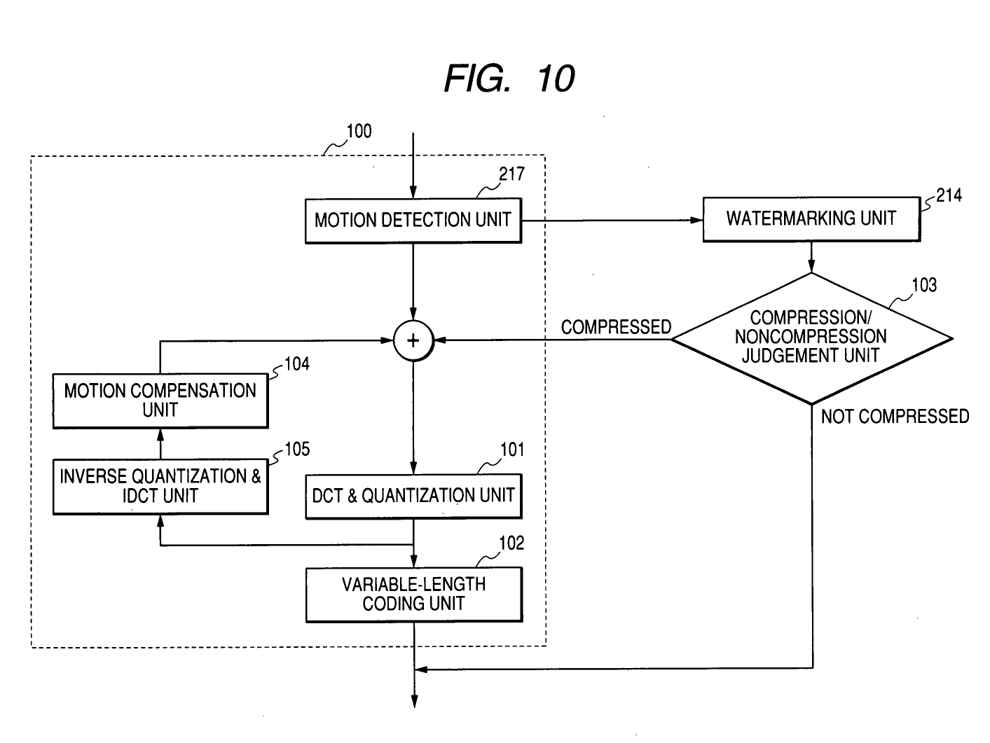

Referring to FIG. 10, the following describes how compressed motion images are watermarked in this electronic watermarking apparatus embodiment of the present invention. FIG. 10 is provided to explain its operation to watermark compressed motion images. In FIG. 10, an image encoder 100 to compress motion images comprises the motion detection unit 217, a DCT & quantization unit 101, a variable-length coding unit 102, a motion compensation unit 104 and an inverse quantization & IDCT unit. Note that an MPEG4 codec is employed here to compress motion images.

The DCT & quantization unit 101 is adapted to perform DCT and quantization processing on an image that is watermarked by the watermarking unit 214. The inverse quantization & IDCT unit 105 and the motion compensation unit 104 are operative to decode an image that is compressed by the DCT & quantization unit 101. In ordinary compressing operation, difference between the decoded frame and the next frame is calculated and processed by the DCT & quantization unit 101. The variable-length coding unit 102 is operative to encode the data, which is output from the DCT & quantization unit 101, and outputs the encoded data as a watermarked compressed motion image.

In this electronic watermarking apparatus according to the embodiment, if it is judged by the compression/noncompression judgment unit 103 that the images are to be compressed, a difference between the decoded frame and the watermarked subsequent frame is calculated and processed by the DCT & quantization unit 101. The variable-length coding unit 102 encodes the data, which is output from the DCT & quantization unit 101, and outputs the encoded data as an watermarked compressed motion image.

In this electronic watermarking apparatus embodiment, both electronic watermarking program 210 and image encoder 100 use the motion detection result of the motion detection unit 217 in order to locate the embed target region. The located embed target region is watermarked by the watermarking unit 214.

Since the embed target region is located based on the motion detection result used for ordinary video compression as described above, it is possible to reduce the time of processing required to concurrently perform both compressing and watermarking operations.

Note that compressed images can be watermarked by watermarking internally decoded images.

In the case of motion images compressed according to MPEG4, it is also possible to specify an MPEG4 object as a target for watermarking. That is, it is judged whether the object is present in a specified region and, if present, watermark information is embedded into the object.

Note that in this embodiment, the operation of each unit described above is implemented by a machine language program which is installed on a general-purpose computer or the like. These units can also be provided as chips and other hardware devices.

In the latter case, the motion detection unit 217 is implemented as a motion detection device capable of detecting the movement of a specified region between one frame and another frame. Likewise, such a processor as a CPU or a LSI on an encoder board may embed watermark information into a specified region in frames.

According to the present invention, since watermark information is embedded into a specific region which moves between frames, it is possible to reduce the processing time required for watermarking and selectively protect a specific portion of each motion image from unauthorized use. In addition, it is possible to embed a different watermark into each of plural regions in the same motion image.

Viewed from another angle, the present invention provides an electronic watermarking program which watermarks digital motion images by running a computer as: image input reception means adapted to receive input digital motion images; image display means for displaying digital motion images; region designation reception means for permit the user for specifying part of a digital motion image as a region to be watermarked; watermark information reception means for permitting the user to specify information which is to be embedded into the region accepted by the region designation reception means; motion detection means for detecting the movement of the embed region accepted by the region designation reception means in order to follow the embed region; and watermarking means for embedding into the embed region information accepted by the watermark information reception means.

Alternatively, the present invention provides an information processing apparatus which comprises: a display device which displays one frame of a motion image stream; an input device to specify a region of the image; a motion detection device which detects the movement of the specified region between the frame and another frame; and a processing device which embeds electronic watermark information into the specified region in the frame and that in another frame.

While the foregoing has described what are considered to be the best mode and/or other examples, it is understood that various modifications may be made therein and that the invention or inventions disclosed herein may be implemented in various forms and been described herein. It is intended by the following claims to claim any and all modifications and variations that fall within the true scope of the inventive concepts.

1. An electronic watermarking apparatus comprising:
a display device which displays a first frame of a motion image stream;
an input device for specifying an area which is to be watermarked with electronic information, the area being part of the first frame; and
a processor which detects a movement of the specified area between the first frame and a second frame of the motion image stream, locates the area in the second frame according to the detected movement and embeds electronic watermark information into the located area in the second frame.

2. An electronic watermarking apparatus according to claim 1, further comprising:
a memory containing a plurality of electronic watermark information sets each of which is associated with a specified area as electronic watermark information to be embedded into the area;
wherein the processor detects a movement of each specified area between the first frame and second frame of the motion image stream, locates the area in the second frame according to the detected movement and embeds the associated electronic watermark information into the located area in the second frame.

3. An electronic watermarking apparatus according to claim 1, wherein the processor detects a movement of the specified area in a frame following, in a forward playback direction of the motion image stream, the area-specified frame, and embeds the electronic watermark information according to the detected movement.

4. An electronic watermarking apparatus according to claim 3, further comprising:
a memory adapted to store image information concerning the specified area and an electronic watermark to be embedded into the specified area;
wherein, if the specified area is not present in a frame, the processor stores in the memory the image information concerning the specified area and the electronic watermark to be embedded into the specified area; and
if the area is found in a further backward frame, the processor restarts watermarking the area in the subsequent frames.

5. An electronic watermarking apparatus according to claim 1, wherein the processor embeds the electronic watermark according to a movement of the specified area in a frame following, in a forward playback direction of the motion image stream, the area-specified frame.

6. An electronic watermarking apparatus according to claim 5, wherein the processor detects a movement of the specified area in a frame immediately preceding, in a forward playback direction of the motion image stream, the area-specified frame.

7. An electronic watermarking apparatus according to claim 5, wherein the processor detects in a forward direction a movement of the specified area in a frame that is located before a predetermined number of frames from the area-specified frame.

8. An electronic watermarking apparatus according to claim 5, further comprising:
a memory adapted to store image information concerning the specified area and an electronic watermark to be embedded into the specified area;
wherein, if the specified area is not present in a frame, the processor stores in the memory the image information concerning the specified area and the electronic watermark to be embedded into the specified area; and
if the area is found in a further forward frame, the processor restarts watermarking the area in the subsequent frames.

9. An electronic watermarking apparatus comprising:
a display which has an image display section to display a motion image stream on the screen;
an input device operative to select an area in a first frame of an motion image stream displayed in the image display section; and
a processor which detects a movement of the selected area between the first frame and a second frame of the motion image stream, locates the area in the second frame according to the detected movement and embeds electronic watermark information into the selected area in the first frame and the located area in the second frame.

10. An electronic watermarking apparatus according to claim 9, wherein the electronic watermark information to be embedded into the selected area is specified from the input device.

11. An electronic watermarking apparatus according to claim 9, further comprising:
a memory adapted to store the information about the selected area and the electronic watermark information to be embedded to the selected area.

12. An electronic watermarking apparatus according to claim 11, wherein the memory stores the information about a plurality of selected areas and a plurality of electronic watermarks to be embedded respectively to the selected areas.

13. An electronic watermarking apparatus according to claim 11, wherein: if the selected area is not present in the second frame, the processor ceases the electronic watermarking operation; and if the selected area is present in another frame, the processor restarts the electronic watermarking operation.

14. An electronic watermarking apparatus according to claim 9, wherein information of the detected movement is a motion vector.

15. An electronic watermarking apparatus according to claim 9, wherein the processor picks out an object in the selected area and embeds watermark information into the object.

16. An electronic watermarking apparatus according to claim 9, wherein the display presents a button which specifies a temporal relation between the first frame and the second frame for motion detection.

17. An electronic watermarking apparatus according to claim 16, wherein if the temporal relation specified by the button is opposite to the forward playback direction, the processor detects a movement of the specified area in a frame immediately preceding, in a forward playback direction of the motion image stream, the area-specified frame.

18. An electronic watermarking apparatus according to claim 9, further comprising:
a non-volatile memory to store the motion image stream watermarked with electronic information.

19. An electronic watermarking method comprising the steps of:
displaying an input digital motion image on a display device;
specifying, by use of an input device, part of the displayed digital motion image as an embed area into which electronic watermark information is to be embedded;
specifying, by use of the input device, information to be embedded as said electronic watermark information;
detecting a movement of the specified embed area; and
locating the specified watermark information to the specified embed area according to the detected movement.
